(19) United States
(12) Patent Application Publication
(10) Pub. No.: US 2026/0320491 A1
(43) Pub. Date: Oct. 15, 2026

(54) FEDERATED ITERATIVE LEARNING WITH IMPORTANCE BASED TRANSMISSION ORDER

(71) Applicant: Telefonaktiebolaget LM Ericsson (publ), Stockholm (SE)

(72) Inventors: Reza MOOSAVI, Linkoping (SE); Henrik RYDEN, Stockholm (SE); Erik G. LARSSON, Linkoping (SE)

(21) Appl. No.: 19/484,809

(22) PCT Filed: May 15, 2023
(86) PCT No.: PCT/EP2023/062916

§ 371 Date: Nov. 14, 2025

(51) Int. Cl. G06N 20/00

(52) U.S. Cl. CPC G06N 20/00

(57) ABSTRACT

There is provided techniques for performing a federated iterative learning process. A method is performed by a server node. The method comprises obtaining an indication of importance per local model parameter of model parameter vectors and an estimate of channel access success per timeslot in a set of timeslots. The method comprises determining, based on the indication of importance per local model parameter and the estimate of channel access success per timeslot, a transmission order in which the local model parameters of the model parameter vectors are to be transmitted for the iteration round. The method comprises transmitting information of the transmission order to client nodes. The method comprises transmitting a global parameter vector of the iteration round to the client nodes. The method comprises receiving local model parameter vectors from the client nodes in at least one of the timeslots. (FIG. 3)

### TECHNICAL FIELD

Embodiments presented herein relate to methods, a server node, a client node, computer programs, and a computer program product for performing a federated iterative learning process.

### BACKGROUND

The increasing concerns for data privacy have motivated the consideration of collaborative machine learning (ML) systems with decentralized data where pieces of training data are stored and processed locally by edge user devices, such as user equipment. Federated learning (FL) is one non-limiting example of a decentralized learning topology, where multiple (possible very large number of) agents, for example implemented in user equipment, participate in training a shared global learning model by exchanging model updates with a centralized parameter server (PS), for example implemented in a network node. In general terms., FL might be regarded as an ML technique that trains an ML (or artificial intelligence; AI) model across multiple decentralized agents, each performing local model training using local data samples. The technique requires multiple interactions of the model, but no exchange of local data samples. In this respect, an ML, or AI, model might be regarded as a data driven algorithm that applies AI/ML techniques to generate a set of outputs based on a set of inputs. Therefore, AI/ML model training might be regarded as a process to train an AI/ML model by learning the input/output relationship in a data driven manner and obtain the trained AI/ML model for inference. An AI/ML model might be delivered over the air interface; either parameters of a model structure known at the receiving end or a new model with parameters. In this respect, a model download refers to model transfer from the PS to the agents, and model upload refers to model transfer from the agents to the PS.

In further details, FL is an iterative process where each global iteration, often referred to as iteration round, is divided into three phases: In a first phase the PS sends the current model parameter vector to all participating agents (i.e., performing model download). In a second phase each of the agents performs one or several steps of a stochastic gradient descent (SGD) procedure on its own training data based on the current model parameter vector and obtains a model update. In a third phase the model updates from all agents are sent to the PS (i.e., performing model upload), which aggregates the received model updates and updates the parameter vector for the next iteration based on the model updates according to some aggregation rule. The first phase is then entered again but with the updated parameter vector as the current model parameter vector.

In general terms, the model updates from all agents are sent over the air, thus using some type of radio access technology (RAT), to the PS. In this respect, there are several concepts for using RATs in both licensed frequency bands and in unlicensed frequency bands. As an example, both the Long-Term Evolution (LTE) air interface and the Next Radio (NR) air interface can be configured for operations in unlicensed spectrum, as well as in licensed spectrum. Such operation is an effective approach to using the available spectrum to increase system capacity. Although unlicensed spectrum does not have all qualities of licensed spectrum, technologies that allow efficient use of it as a complement to licensed deployments have therefore the potential to increase the spectrum utilization as a whole.

When a wireless device, such as user equipment, is operated in unlicensed spectrum, in many jurisdictions it is required that the wireless device senses the medium and determines that the medium is not occupied before the wireless device starts transmitting. This operation is often referred to as listen-before-talk (LBT). In more detail, LBT is designed for unlicensed spectrum co-existence with other RATs. In this mechanism, the wireless device applies a Clear Channel Assessment (CCA) check (i.e. channel sensing) before any transmission. The wireless device uses energy detection (ED) over a time period and compares the energy to a certain threshold (ED threshold) in order to determine whether a channel is idle or not (i.e., whether the medium is occupied or not). LBT parameter settings (including ED) may be determined for wireless devices in a network by a network node configuring the wireless devices. Limits may be set according to pre-defined rules or tables in specifications or be taken from regulatory requirements for operation in a certain region. Such limits are part of the European Telecommunications Standards Institute (ETSI) harmonized standard in Europe as well as 3rd Generation Partnership Project (3GPP) specifications for operation of LTE/NR in unlicensed spectrum.

When model parameters are transmitted in an unlicensed spectrum, each agent might thus be obliged to perform an LBT prior to performing a model parameter transmission. This might lead to only a subset of the agents being able to transmit in each LBT window, where in each LBT window only a subset of the model parameters are transmitted. This leads to longer training duration and/or worse training performance, in particular if important parameters are not transmitted by all agents. The issue is pronounced when the model update is of large size such that the transmission does not fit in a single LBT window and hence where the transmission needs to span over several LBT windows—each requiring the use of LBT by the participating agents.

One way to mitigate this is for the agents to, in a dedicated occasion after each over-the-air aggregation and in dedicated message, sends any model parameters that could not be transmitted (i.e., the model parameters for the occasions where the user equipment did not participate in a transmission). However, this would lead to extra transmission overhead and delay since all user equipment need to send the message within the same timeframe, whilst still obliging to the LBT requirements.

In general terms, the agents can be implemented as client nodes (with one agent per each client node) whereas the PS can be implemented as a server node. Hence, there is still a need for improved transmission of model parameters from client nodes to the server node when performing a federated iterative learning process.

### SUMMARY

An object of embodiments herein is to address the above issues.

A particular object is to improve the transmission of model parameters from client nodes, i.e. agents, to the server node, i.e. PS, in the context of LBT or other scenarios where a set of timeslots are available for transmissions of model parameter vectors.

A particular object is to improve the transmission of model parameters from client nodes, i.e. agents, to the server node, i.e. PS, without increasing the transmission overhead.

A further particular object is to improve the transmission of model parameters from client nodes, i.e. agents, to the server node, i.e. PS, without increasing the transmission delay.

According to a first aspect there is presented a method for performing a federated iterative learning process with client nodes. The method is performed by a server node. Per each iteration round of the federated iterative learning process, each of the client nodes are configured to transmit a local model parameter vector with locally computed computational results to the server node. A set of timeslots are available for the transmission of the local model parameter vector. The method per each iteration round comprises obtaining an indication of importance per local model parameter of the model parameter vectors and an estimate of channel access success per timeslot in the set of timeslots. The method per each iteration round comprises determining, based on the indication of importance per local model parameter and the estimate of channel access success per timeslot, a transmission order in which the local model parameters of the model parameter vectors are to be transmitted for the iteration round. The method per each iteration round comprises transmitting information of the transmission order to the client nodes. The method per each iteration round comprises transmitting a global parameter vector of the iteration round to the client nodes. The method per each iteration round comprises receiving local model parameter vectors from the client nodes in at least one of the timeslots.

According to a second aspect there is presented a server node for performing a federated iterative learning process with client nodes. Per each iteration round of the federated iterative learning process, each of the client nodes are configured to transmit a local model parameter vector with locally computed computational results to the server node. A set of timeslots are available for the transmission of the local model parameter vector. The server node comprises processing circuitry. The processing circuitry is configured to cause the server node, to per each iteration round obtain an indication of importance per local model parameter of the model parameter vectors and an estimate of channel access success per timeslot in the set of timeslots. The processing circuitry is configured to cause the server node, to per each iteration round determine, based on the indication of importance per local model parameter and the estimate of channel access success per timeslot, a transmission order in which the local model parameters of the model parameter vectors are to be transmitted for the iteration round. The processing circuitry is configured to cause the server node, to per each iteration round transmit information of the transmission order to the client nodes. The processing circuitry is configured to cause the server node, to per each iteration round transmit a global parameter vector of the iteration round to the client nodes. The processing circuitry is configured to cause the server node, to per each iteration round receive local model parameter vectors from the client nodes in at least one of the timeslots.

According to a third aspect there is presented a server node for performing a federated iterative learning process with client nodes. Per each iteration round of the federated iterative learning process, each of the client nodes are configured to transmit a local model parameter vector with locally computed computational results to the server node. A set of timeslots are available for the transmission of the local model parameter vector. The server node comprises an obtain module configured to, per each iteration round, obtain an indication of importance per local model parameter of the model parameter vectors and an estimate of channel access success per timeslot in the set of timeslots. The server node comprises a determine module configured to, per each iteration round, determine, based on the indication of importance per local model parameter and the estimate of channel access success per timeslot, a transmission order in which the local model parameters of the model parameter vectors are to be transmitted for the iteration round. The server node comprises a transmit module configured to, per each iteration round, transmit information of the transmission order to the client nodes. The server node comprises a transmit module configured to, per each iteration round, transmit a global parameter vector of the iteration round to the client nodes. The server node comprises a receive module configured to, per each iteration round, receive local model parameter vectors from the client nodes in at least one of the timeslots.

According to a fourth aspect there is presented a computer program for a server node to perform a federated iterative learning process with client nodes. Per each iteration round of the federated iterative learning process, each of the client nodes are configured to transmit a local model parameter vector with locally computed computational results to the server node. A set of timeslots are available for the transmission of the local model parameter vector. The computer program comprises computer code which, when run on processing circuitry of the server node, causes the server node to, per each iteration round, causes the server node to perform actions. One action comprises the server node to obtain an indication of importance per local model parameter of the model parameter vectors and an estimate of channel access success per timeslot in the set of timeslots. One action comprises the server node to determine, based on the indication of importance per local model parameter and the estimate of channel access success per timeslot, a transmission order in which the local model parameters of the model parameter vectors are to be transmitted for the iteration round. One action comprises the server node to transmit information of the transmission order to the client nodes. One action comprises the server node to transmit a global parameter vector of the iteration round to the client nodes. One action comprises the server node to receive local model parameter vectors from the client nodes in at least one of the timeslots.

According to a fifth aspect there is presented a method for performing a federated iterative learning process with a server node. The method is performed by a client node. Per each iteration round of the federated iterative learning process, the client node is configured to transmit a local model parameter vector with locally computed computational results to the server node. A set of timeslots are available for the transmission of the local model parameter vector. The method per each iteration round comprises. The method per each iteration round comprises receiving information of a transmission order in which the local model parameters of the model parameter vectors are to be transmitted for the iteration round. The transmission order is based on an indication of importance per local model parameter and an estimate of channel access success per timeslot. The method per each iteration round comprises receiving a global parameter vector of the iteration round from the server node. The method per each iteration round comprises transmitting the local model parameter vector, as determined based on the global parameter vector and local data, for the iteration round to the server node in at least one of the timeslots. The local model parameters of the local model parameter vector are transmitted in accordance with the transmission order.

According to a sixth aspect there is presented a client node for performing a federated iterative learning process with a server node. Per each iteration round of the federated iterative learning process, the client node is configured to transmit a local model parameter vector with locally computed computational results to the server node. A set of timeslots are available for the transmission of the local model parameter vector. The client node comprises processing circuitry. The processing circuitry is configured to cause the client node to, per each iteration round, receive information of a transmission order in which the local model parameters of the model parameter vectors are to be transmitted for the iteration round. The transmission order is based on an indication of importance per local model parameter and an estimate of channel access success per timeslot. The processing circuitry is configured to cause the client node to, per each iteration round, receive a global parameter vector of the iteration round from the server node. The processing circuitry is configured to cause the client node to, per each iteration round, transmit the local model parameter vector, as determined based on the global parameter vector and local data, for the iteration round to the server node in at least one of the timeslots. The local model parameters of the local model parameter vector are transmitted in accordance with the transmission order.

According to a seventh aspect there is presented a client node for performing a federated iterative learning process with a server node. Per each iteration round of the federated iterative learning process, the client node is configured to transmit a local model parameter vector with locally computed computational results to the server node. A set of timeslots are available for the transmission of the local model parameter vector. The client node comprises a receive module configured to, per each iteration round, receive information of a transmission order in which the local model parameters of the model parameter vectors are to be transmitted for the iteration round. The transmission order is based on an indication of importance per local model parameter and an estimate of channel access success per timeslot. The client node comprises a receive module configured to, per each iteration round, receive a global parameter vector of the iteration round from the server node. The client node comprises a transmit module configured to, per each iteration round, transmit the local model parameter vector, as determined based on the global parameter vector and local data, for the iteration round to the server node in at least one of the timeslots. The local model parameters of the local model parameter vector are transmitted in accordance with the transmission order.

According to an eighth aspect there is presented a computer program for a client node to perform a federated iterative learning process with a server node. Per each iteration round of the federated iterative learning process, the client node is configured to transmit a local model parameter vector with locally computed computational results to the server node. A set of timeslots are available for the transmission of the local model parameter vector. The computer program comprises computer code which, when run on processing circuitry of the client node, causes the client node to, per each iteration round, perform actions. One action comprises the client node to receive information of a transmission order in which the local model parameters of the model parameter vectors are to be transmitted for the iteration round. The transmission order is based on an indication of importance per local model parameter and an estimate of channel access success per timeslot. One action comprises the client node to receive a global parameter vector of the iteration round from the server node. One action comprises the client node to transmit the local model parameter vector, as determined based on the global parameter vector and local data, for the iteration round to the server node in at least one of the timeslots. The local model parameters of the local model parameter vector are transmitted in accordance with the transmission order.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects enable important local model parameter vectors to be transmitted in timeslots with high probability of success.

Advantageously, these aspects provide efficient transmission of model parameters from the client nodes to the server node in the context of LBT or other scenarios where a set of timeslots are available for transmissions of model parameter vectors.

Advantageously, these aspects provide efficient transmission of model parameters from the client nodes to the server node without increasing the transmission overhead.

Advantageously, these aspects provide efficient transmission of model parameters from the client nodes to the server node without increasing the transmission delay.

Advantageously, these aspects provide improved federated iterative learning where the client nodes operate in unlicensed spectrum.

Advantageously, these aspects increase the probability that important parameters are transmitted by more of the client nodes.

Advantageously, these aspects increase the probability that important parameters are transmitted by client nodes with unique datasets.

Advantageously, these aspects yield faster convergence and require less overhead, in terms of network resources, than the methods mentioned in the background section.

Advantageously, these aspects provide improved robustness for federated iterative learning process that rely on over-the-air aggregation and where the client nodes operate in unlicensed spectrum.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a signalling diagram according to an example;

FIGS. 3, 4, and 5 are flowcharts of methods according to embodiments;

FIGS. 6 and 7 show simulation results according to embodiments;

FIG. 8 is a signaling diagram of a method according to an embodiment;

FIGS. 9, 10, and 11 show simulation results according to embodiments;

FIG. 12 is a schematic diagram showing functional units of a server node according to an embodiment;

FIG. 13 is a schematic diagram showing functional modules of a server node according to an embodiment;

FIG. 14 is a schematic diagram showing functional units of a client node according to an embodiment;

FIG. 15 is a schematic diagram showing functional modules of a client node according to an embodiment;

FIG. 16 shows one example of a computer program product comprising computer readable means according to an embodiment;

FIG. 17 is a schematic diagram illustrating a telecommunication network connected via an intermediate network to a host computer in accordance with some embodiments; and

FIG. 18 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The wording that a certain data item, piece of information, etc. is obtained by a first device should be construed as that data item or piece of information being retrieved, fetched, received, or otherwise made available to the first device. For example, the data item or piece of information might either be pushed to the first device from a second device or pulled by the first device from a second device. Further, in order for the first device to obtain the data item or piece of information, the first device might be configured to perform a series of operations, possible including interaction with the second device. Such operations, or interactions, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the first device.

The wording that a certain data item, piece of information, etc. is provided by a first device to a second device should be construed as that data item or piece of information being sent or otherwise made available to the second device by the first device. For example, the data item or piece of information might either be pushed to the second device from the first device or pulled by the second device from the first device. Further, in order for the first device to provide the data item or piece of information to the second device, the first device and the second device might be configured to perform a series of operations in order to interact with each other. Such operations, or interaction, might involve a message exchange comprising any of a request message for the data item or piece of information, a response message comprising the data item or piece of information, and an acknowledge message of the data item or piece of information. The request message might be omitted if the data item or piece of information is neither explicitly nor implicitly requested by the second device.

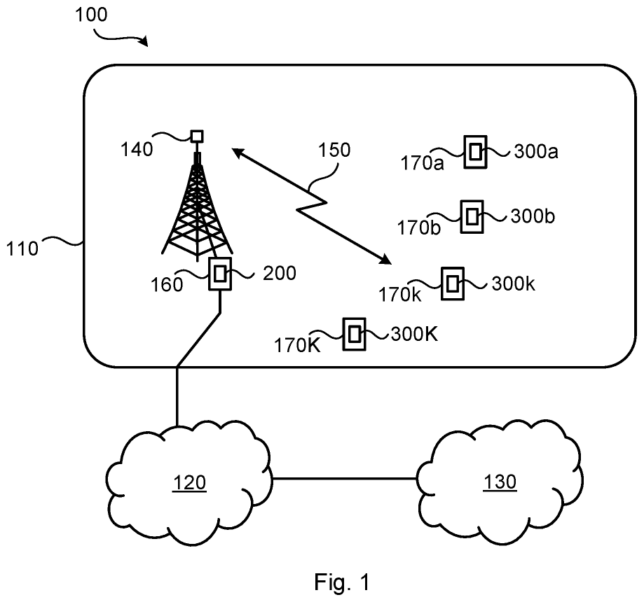

FIG. 1 is a schematic diagram illustrating a communication network 100 where embodiments presented herein can be applied. The communication network 100 could be a third generation (3G) telecommunications network, a fourth generation (4G) telecommunications network, a fifth (5G) telecommunications network, a sixth (6G) telecommunications network, and support any 3GPP telecommunications standard.

The communication network 100 comprises a transmission and reception point 140 configured to provide network access to user equipment 170a, 170k, 170K in an (radio) access network 110 over a radio propagation channel 150. The access network 110 is operatively connected to a core network 120. The core network 120 is in turn operatively connected to a service network 130, such as the Internet. The user equipment 170a: 170K is thereby, via the transmission and reception point 140, enabled to access services of, and exchange data with, the service network 130.

Operation of the transmission and reception point 140 is controlled by a network node 160. The network node 160 might be part of, collocated with, or integrated with the transmission and reception point 140.

Examples of network nodes 160 are (radio) access network nodes, radio base stations, base transceiver stations, Node Bs (NBs), evolved Node Bs (eNBs), gNBs, access points, access nodes, and integrated access and backhaul nodes. Examples of user equipment 170a: 170K are wireless devices, mobile stations, mobile phones, handsets, wireless local loop phones, smartphones, laptop computers, tablet computers, network equipped sensors, network equipped vehicles, and so-called Internet of Things devices.

It is assumed that the user equipment 170a: 170K are to be utilized during an iterative learning process and that the user equipment 170a: 170K as part of performing the iterative learning process are to report computational results to the network node 160. The network node 160 therefore comprises, is collocated with, or integrated with, a server node 200. Hence, the server node 200 might be part of, collocated with, or integrated with, the network node 160. As noted above, in the context of (federated) iterative learning procedures, the server node may equally be referred to as a parameter server. Each of the user equipment 170a: 170K comprises, is collocated with, or integrated with, a respective client node 300a:300K. Hence, each client node 300a:300K might be part of, collocated with, or integrated with, a respective user equipment 170a: 170K. As noted above, in the context of (federated) iterative learning procedures, the client nodes may equally be referred to as agents. In some examples, the server node 200 and the client nodes 300a:300K are provided in a distributed computing architecture.

Consider a system with a server node 200 and K client nodes 300a:300K. The server node 200 and the client nodes 300a:300K communicate over a shared medium for which broadcasting is possible, i.e., transmission of information that can be received simultaneously by several client nodes 300a:300K. A prime example of such a medium is the wireless channel, where techniques such as Long Term Evolution (LTE) and New Radio (NR) and as standardized by the third generation partnership project (3GPP). Henceforth a wireless communication medium is assumed.

A learning model is iteratively trained. The procedure for one iteration round will be summarized next. First, the server node 200 broadcasts a parameter vector (which could be differentially to a previously broadcasted model, as detailed below). This parameter vector is assumed to be received by the client nodes 300a:300K. Each of the client nodes 300a:300K then computes a local model update based on local training data, and then sends their locally obtained updates to the server node 200. Finally, the server node 200 aggregates all received local updates to update the learning model.

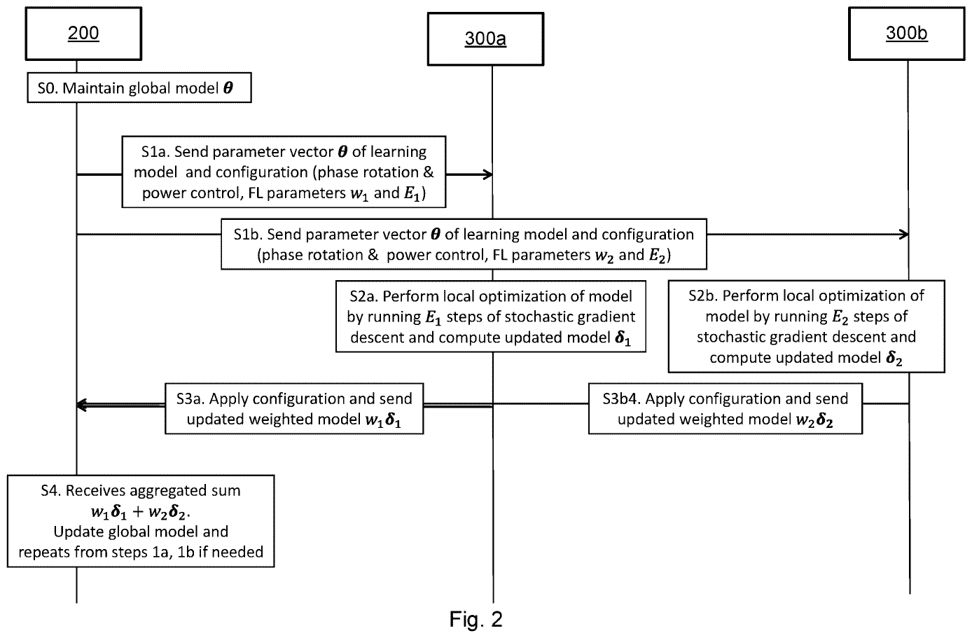

Reference is next made to the signalling diagram of FIG. 2, illustrating an example of a nominal iterative learning process. Consider a setup with K client nodes 300a:300K, and one server node 200. Each transmission from the client nodes 300a:300K is allocated N resource elements (REs). These can be time/frequency samples, or spatial modes. For simplicity, but without loss of generality, the example in FIG. 2 is shown for two client nodes 300a, 300b, but the principles hold also for larger number of client nodes 300a:300K.

The server node 200 updates its estimate of the learning model (maintained as a global model θ in step S0), as defined by a parameter vector θ(i), by performing global iterations with an iteration time index i. The parameter vector θ(i) is assumed to be an N-dimensional vector. At each iteration i, the following steps are performed:

Steps S1a, S1b: The server node 200 sends the current parameter vector of the learning model, θ(i), to the client nodes 300a, 300b.

In this respect, there could be different ways in which the current parameter vector of the learning model, θ(i), is sent to the client nodes 300a, 300b, such as unicast digital transmission, broadcast transmission, or multicast transmission. Some properties of each of these types of transmissions will be disclosed next.

With unicast digital transmission, the server node 200 allocates orthogonal time, frequency, and/or spatial, resources to each client node 300a, 300b. For each client node 300a, 300b, a corresponding transmission rate as well as coding and modulation scheme are determined. The model, or a differential update compared to the previously broadcasted model, is quantized and compressed using a source code. For each client node 300a, 300b, a modulation and coding scheme is applied, tailored to the rate that the channel to this client node 300a, 300b can support. Each client node 300a, 300b then decodes the transmission that contains the model (or its differential update).

With broadcast transmission, the server node 200 transmits in such a way that all client nodes 300a, 300b can decode the model. Since the properties of the radio propagation channel 150 differ for each of the client nodes 300a, 300b, for example resulting in the pathloss being different for the different client nodes 300a, 300b, this can require that the transmission rate is selected very low (using heavy error control coding). An alternative is to use an error control code that can be decoded using only partially received bits. For example, if one uses a channel code (e.g., low density parity check codes; LDPC) with a pseudo-random structure of its parity check matrix, then the client nodes 300a, 300b with small pathloss (and therefore a high received sign al to noise ratio; SNR) may decode the model broadcast after receiving a relatively small number of bits. In contrast, client nodes 300a, 300b with a higher pathloss will have to receive more parity bits before decoding is possible. Client nodes experiencing a comparatively high SNR (compared to other client nodes) could not only decode the model faster but also start their training computation (e.g., stochastic gradient) earlier, hence enabling a reduction in clock frequency of the computation which in turn results in lower power consumption.

With multicast transmission, the client nodes 300a, 300b can be partitioned in different groups, where one respective uplink pilot resource is assigned per each group. In this way, when beamformed transmission is used, multiple beams can be used, where each beam is adapted to serve a particular group of client nodes 300a, 300b.

Multicast transmission might be regarded as a combination of unicast and broadcast techniques and there may be circumstances where such grouping is preferable for performance reasons.

Steps S2a, S2b: Each client node 300a, 300b performs a local optimization of the model by running T steps of a stochastic gradient descent update on θ(i), based on its local training data;

θₖ(i,τ)=θₖ(i,τ−1)−ηₖ∇fₖ(θₖ(i,τ−1))τ=1, . . . ,T,

where ηₖ is a weight and fₖ is the objective function used at client node k (and which is based on its locally available training data).

Steps S3a, S3b: Each client node 300a, 300b transmits to the server node 200 their model update δₖ (i);

δₖ(i)=θₖ(i,T)−θₖ(i,0),

where θₖ(i, 0) is the model that client node k received from the server node 200. Steps S3a, S3b may be performed sequentially, in any order, or simultaneously.

Step S4: The server node 200 updates its estimate of the parameter vector θ(i) by adding to it a linear combination (weighted sum) of the updates received from the client nodes 300a, 300b;

θ(i+1)=θ(i)+w₁δ₁(i)+w₂δ₂(i)

where wₖ are weights.

Assume now that there are K client nodes and hence K model updates. When the model updates {δ₁, . . . , δ_{K}} (where the time index has been dropped for simplicity) from the client nodes 300a:300K over a wireless communication channel, there are specific benefits of using direct analog modulation. For analog modulation, the k:th client node could transmit the N components of 8k directly over N resource elements (REs). Here an RE could be, for example: (i) one sample in time in a single-carrier system, or (ii) one subcarrier in one orthogonal frequency-division multiplexing (OFDM) symbol in a multicarrier system, or (iii) a particular spatial beam or a combination of a beam and a time/frequency resource.

One benefit of direct analog modulation is that the superposition nature of the wireless communication channel can be exploited to compute the aggregated update, δ₁+δ₂+ . . . +δ_{K}. More specifically, rather than sending δ₁, . . . , δ_{K} to the server node 200 on separate channels, the client nodes 300a:300K could send the model updates {δ₁, . . . , δ_{K}} simultaneously, using N REs, through linear analog modulation. The server node 200 could then exploit the wave superposition property of the wireless communication channel, namely that {δ₁, . . . , δ_{K}} add up “in the air”. Neglecting noise and interference, the server node 200 would thus receive the linear sum, δ₁+δ₂+ . . . +δ_{K}, as desired. That is, the server node 200 ultimately is interested only in the aggregated model update δ₁+δ₂+ . . . +δ_{K}, but not in each individual parameter vector {δ₁, . . . , δ_{K}}. This technique can thus be referred to as iterative learning with over-the-air computation.

The over-the-air computation assumes that appropriate power control is applied (such that all transmissions of {δₖ} are received at the server node 200 with the same power), and that each transmitted 8k is appropriately phase-rotated prior to transmission to pre-compensate for the phase rotation incurred by the channel from client node k to the server node 200.

One benefit of the thus described over-the-air computation is the savings of radio resources. With two client nodes (K=2), 50% resources are saved compared to standard FL since the two client nodes can send their model updates simultaneously in the same RE. With K client nodes, only a fraction 1/K of the nominally required resources are needed.

As disclosed above, there is still a need for improved transmission of model parameters from client nodes to the server node when performing a federated iterative learning process.

According to at least some of the herein disclosed embodiments there is therefore provided techniques for performing a federated iterative learning process, where per each iteration round of the federated iterative learning process, each of the client nodes 300a:300K is configured to transmit a local model parameter vector with locally computed computational results to the server node 200 in a set of available timeslots. According to at least some of the herein disclosed embodiments, a transmission order in which the local model parameters of the model parameter vectors are to be transmitted is determined for each iteration round at least based on the importance per local model parameter of the model parameter vectors and an estimate of channel access success per timeslot in the set of timeslots.

The embodiments disclosed herein in particular relate to techniques for performing a federated iterative learning process. In order to obtain such techniques, there is provided a server node 200, a method performed by the server node 200, a computer program product comprising code, for example in the form of a computer program, that when run on processing circuitry of the server node 200, causes the server node 200 to perform the method. In order to obtain such techniques, there is further provided a client node 300k, a method performed by the client node 300k, and a computer program product comprising code, for example in the form of a computer program, that when run on processing circuitry of the client node 300k, causes the client node 300k to perform the method.

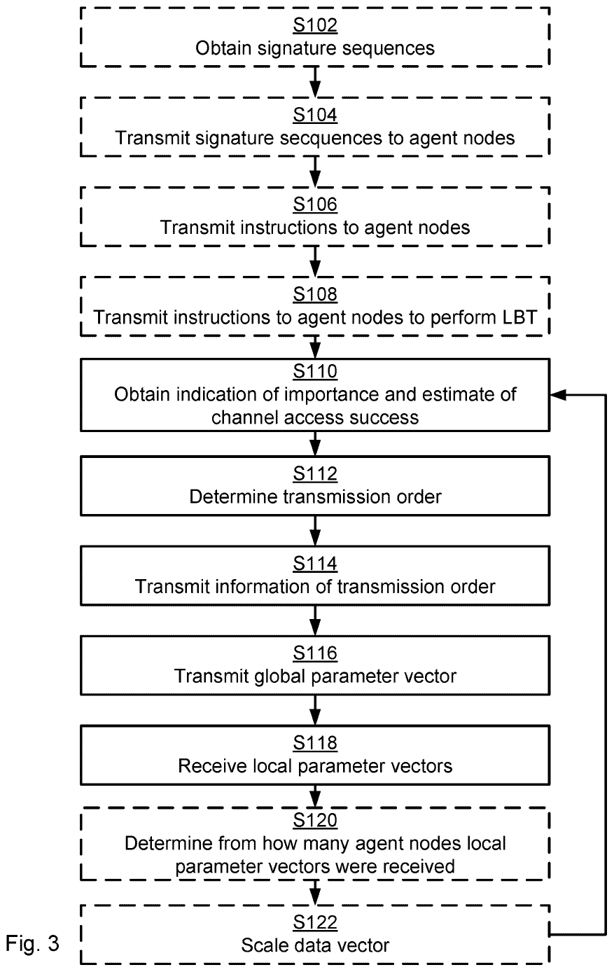

Reference is now made to FIG. 3 illustrating a method as performed by a server node 200 for performing a federated iterative learning process with client nodes 300a:300K according to an embodiment. Per each iteration round of the federated iterative learning process, each of the client nodes 300a:300K are configured to transmit a local model parameter vector with locally computed computational results to the server node 200. A set of timeslots are available for the transmission of the local model parameter vector. Actions as taken by the server node 200 per each iteration round of the federated iterative learning process will be disclosed next.

S110: The server node 200 obtains an indication of importance per local model parameter of the model parameter vectors and an estimate of channel access success per timeslot in the set of timeslots.

S112: The server node 200 determines, based on the indication of importance per local model parameter and the estimate of channel access success per timeslot, a transmission order in which the local model parameters of the model parameter vectors are to be transmitted for the iteration round. Different ways in which the transmission order can be determined will be disclosed below. Needless to say, all client nodes 300a:300K need to transmit the same parameters of the local parameter vectors and it is therefore implicit that the transmission order is the same for all the client nodes 300a:300K. As the importance per local model parameter and/or the channel access success might change over time, the transmission order might also change from one set of timeslots to the next set of timeslots, or even per every timeslot.

S114: The server node 200 transmits information of the transmission order to the client nodes 300a:300K.

S116: The server node 200 transmits a global parameter vector of the iteration round to the client nodes 300a:300K.

S118: The server node 200 receives local model parameter vectors from the client nodes 300a:300K in at least one of the timeslots.

It is here thus noted that one local model parameter vector as transmitted per client node 300a:300K is received. That is, the maximum number of received local model parameter vectors per each iteration round is K. It could be that, for a given timeslot, not all client nodes 300a:300K will send any local model parameter vector. Therefore, the server node 200 might in S118 receive local model parameter vectors from only a subset of the client nodes 300a:300K. Further details in this regard will be disclosed below.

Embodiments relating to further details of performing a federated iterative learning process as performed by the server node 200 will now be disclosed with continued reference to FIG. 3.

In some examples, the timeslots are represented by an NR/LTE time reference. In some examples, the start, end, and/or duration, of the timeslots is/are defined by an absolute time (for example provided from a satellite positioning system, or the like).

In some examples the local model parameter vectors are transmitted over-the-air and using analog linear modulation. Therefore, in some embodiments the local model parameter vectors are received as a superposition of the of the local model parameter vectors as aggregated over-the-air for the iteration round.

There can be different ways in which the information of the transmission order is transmitted to the client nodes 300a:300K in S114. In some examples the information of the transmission order is transmitted in a broadcast message at the start of each iteration round. In some examples the condition that the information of the transmission order is transmitted at the start of each iteration round is relaxed and only sent on demand, for example, when the transmission order is the same for a number of consecutive iteration rounds. Then the client nodes can thus assume that the model parameter order is the same as last transmission until a further instruction/configuration is broadcast. In other examples, the information of the transmission order is transmitted in individual messages for each client node, possibly together with some transmission configuration (for example which power and phase to use).

In some examples, the server node 200 configures an idle period to allow for interfering traffic to be completed (emptying its buffers). The idle period can be configured to occur before the local model parameter vectors are to be transmitted from the client nodes in each iteration round.

There could be different levels of granularity for which the transmission order is defined. In some examples, the transmission order is defined per each individual local model parameters. In other examples, the transmission order is defined per each block of local model parameters. For the latter, model parameters might thus be grouped together in pre-determined groups where an importance score is computed for each group rather than for each individual parameter.

Different ways in which the transmission order can be determined will be disclosed next.

In general terms, the transmission order can be determined based on one or more of the importance per local model parameter (i.e., the model parameter importance), the LBT success probability (i.e., the estimated channel access success per timeslot), possibly in combination with the dataset importance per client node.

Aspects of the model parameter importance will be disclosed next.

The model parameter importance can be estimated in various ways. In general terms, the model parameter importance might be determined by the server node 200 alone, by the server node 200 in collaboration with one or more of the client nodes 300a:300K, or by one or more of the client nodes 300a:300K alone.

Embodiments where the indication of importance is obtained by being determined by the server node 200 itself will be disclosed next.

In some aspects, the server node 200 might determine the the indication of importance by measuring the output variation and associated accuracy/loss impact when performing perturbations of a given model parameter. In one example, the server node 200, if not having access to any test data, uses a set of random inputs to the global model and measures how sensitive the output is to a perturbation. The sensitivity can here pertain to if the output statistics is very different when applying a certain model parameter perturbation in comparison to no perturbation. In another example, if the server node 200 has access to some training data, the indication of importance can be obtained by determining how much the accuracy, or loss, degrades with a certain model parameter perturbation. Thus, in some embodiments, the server node 200 determines the indication of importance by estimating sensitivity of the local model parameters to perturbation, and wherein the higher the sensitivity, the higher the importance is.

In some aspects, the indication of importance can be based on the magnitude of the model parameters, as shown in simulation results that will be presented below. That is, in some embodiments, the server node 200 determines the indication of importance by estimating magnitude per each of the local model parameters, and wherein the lower the magnitude, the higher the importance is.

In case a neural network is used by the server node 200 as part of performing the federated iterative learning process, for example as part of updating the global parameter vector in each round, the server node 200 might try to reduce (i.e., sparsify) the neural network by setting local model parameters with low magnitudes to zero. In case this does not result in any substantial loss of accuracy, this is an indication that the local model parameters are of less importance than higher-magnitude weights. By testing different combinations. i.e., by setting different local model parameters to zero, the server node 200 is able to determine which local model parameters are important and which local model parameters that are not important, and thereby determine an indication of importance per each local model parameter. Further, the server node 200 can use such insights to determine the indication of importance by first aggregating the model parameters into a cumulative distribution, and then associate certain percentiles with a certain importance score.

In some examples, the indication of importance might be computed depending on the time-evolution of the local model parameter (e.g., by computing derivatives to show how much a local model parameter has changed compared to the last iteration). In this case, local model parameter with higher change rate can get higher importance scores.

Embodiments where the indication of importance is obtained by being determined by the server node 200 in collaboration with one or more of the client nodes 300a:300K will be disclosed next.

The client nodes 300a:300K can assist the server node 200 in computing the importance scores. This can be done for example by having the client nodes 300a:300K send a subset of their training data to the server node 200, to assist the server node 200 to estimate the indication of importance.

Embodiments where the indication of importance is obtained by being determined by one or more of the client nodes 300a:300K will be disclosed next.

For example, the indication of importance can be computed by the client nodes 300a:300K, based on configuration provided by the server node 200, and then reported from the client nodes 300a:300K to the server node 200. Hence, in some embodiments, the indication of importance is obtained by weighting indications of importance per local model parameter as received from the client nodes 300a:300K.

In such cases, any of the techniques disclosed above with reference to the determination of the indication of importance as made by the server node 200 alone can be used by the client nodes 300a:300K for computation of the indication of importance. This has the advantage that the indication of importance is computed directly by the client nodes 300a:300K that have access to local training data, yielding accurate importance estimates.

Embodiments where the indication of importance is obtained by being determined by the server node 200 in collaboration with one or more of the client nodes 300a:300K will be disclosed next.

For example, for a given model parameter, let sₙ be a score representing the indication of importance as determined by the server node and let sₐ be a score representing the indication of importance as determined by one or more of the client node. Then, as one example, the combined indication of importance may be computed as sₙ+sₐ (equivalent to taking the average). As another example, the combined indication of importance may be taken as max (sₙ, sₐ) reflecting that if either the server node 200 or one or more of the client nodes 300a:300K, or both, assigns a high score, the combined indication of importance should be high. In further examples, other operations such as mean operations, or min operations are used.

Aspects of the LBT success probability will be disclosed next.

In some embodiments, according to the transmission order, the local model parameters with highest importance are to be transmitted in the timeslots with estimated highest channel access success.

In some aspects, in each timeslot the client nodes contend for the channel using LBT, and thus transmissions from the client nodes are subject to LBT. Therefore, in some embodiments, the server node 200 is configured to perform (optional) action S108.

S108: The server node 200 transmits instructions to the client nodes 300a:300K to perform an LBT procedure for each timeslot in which any local model parameter of the local model parameter vector is to be transmitted. Action S108 needs not to be performed per each iteration round.

As for the estimation of the model parameter importance, the estimate of channel access success per timeslot can be obtained in various ways. In general terms, the channel access success per timeslot might be estimated by the server node 200 alone, by the server node 200 in collaboration with one or more of the client nodes 300a:300K, or by one or more of the client nodes 300a:300K alone.

Embodiments where the estimate of channel access success per timeslot is obtained by being determined by the server node 200 itself will be disclosed next.

In some examples, the server node 200 estimates the probability of success for LBT in a certain timeslot based on information of historical transmissions of local model parameter vectors. That is, in some embodiments, the server node 200 determines the estimate of channel access success per timeslot based on successful reception of previous transmissions of local model parameter vector from the client nodes 300a:300K. For example, such historical information can indicate that a client node has a certain percentage of successful transmission in a certain future timeslot.

In some examples, the server node 200 assumes that the LBT success probability is higher in an earlier timeslot than in a later timeslot. That is, in some embodiments, the server node 200 determines the estimate of channel access success per timeslot to be higher the earlier in time the timeslot occurs.

In some examples, the server node 200 acquires further information about other RATs operating in the same unlicensed band (for example by message exchange between network nodes, by retrieving information from an inventory where the network nodes of each RAT register their traffic, by the number of its active user equipment, etc). This information can then be used by the server node 200 to estimate the LBT success probability. That is, in some embodiments, the server node 200 determines the estimate of channel access success per timeslot based on radio access technologies operating within, or adjacent, a bandwidth within which the local model parameter vectors are transmitted.

Embodiments where the estimate of channel access success per timeslot is obtained from directly from the client nodes 300a:300K or based on information provided by the client nodes 300a:300K will be disclosed next.

For example, the server node might estimate the channel access success per timeslot by weighting estimates of channel access success per timeslot as received from the client nodes 300a:300K. Therefore, in some examples, the server node requests the client nodes to estimate the probability of LBT success.

In some examples, the client nodes estimate the probability of LBT success by fitting a Markov model to the observed interference strength. For example, such a Markov model could be represented by a Markov chain with two states; one state representing an idle channel and one state representing a busy, or occupied, channel, with transition probabilities in between. More generally, the Markov chain could have more states, representing different states that other user equipment located in the vicinity are in. The transition probabilities can, for instance, be estimated using an expectation-maximization (EM) algorithm.

Aspects of the dataset importance per client node will be disclosed next.

In some embodiments, the transmission order further is based on a dataset importance per at least one of the client nodes 300a:300K. Therefore, in some examples, the client nodes 300a:300K indicate their dataset importance to the server node. The dataset importance can, for example, comprise statistics of the response variable, the number of data samples, the time/place at which data is collected, etc. The dataset importance might indicate the age of the data and/or the time that has passed since a give client node was involved in a model update the last time.

In the heterogenous-data scenario a specific client node may have access to very unique data, and therefore that specific client node should not be ignored in the learning process. As an example of an extreme case, consider handwritten digit recognition with 100 client node; if 99 of the client nodes have access to samples of the digits “0” to “8” but only one single client node has access to the digit “9”, then the dataset importance for this single client node is high.

In some aspects, when each of the local model parameter vectors is sent as a stream of analog values over the air, it might be challenging for the server node to detect from how many of the client nodes local model parameter vector were received. This issue might arise in operations in unlicensed spectrum where the transmission of the local model parameter vector from client nodes are subject to LBT, or other scenarios where a set of timeslots are available for transmissions of the model parameter vectors. The issue is particularly pronounced when the local model parameter vectors are of large size such that the transmission of the local model parameter vector for one iteration does not fit in a single LBT window and hence needs to span over several timeslots—each requiring the use of LBT by the participating client nodes. In this case, the aggregated model update vector & might contain several chunks with unknown number of participating client nodes and hence the over-the-air computation might not work. One way to address this issue could be for the client nodes to in a dedicated occasion after each over-the-air aggregation indicating in a dedicated message the occasions where the user equipment participated in an over-the-air transmission. However, this would lead to extra transmission overhead and/or delay since all user equipment need to send the message within the same time frame, whilst obliging to the LBT requirements.

According to at least some of the herein disclosed embodiments there is therefore provided techniques according to which the client nodes append a signature sequence when transmitting their local model parameter vectors. The signature sequences might have the property of yielding low correlations amongst each other and can therefore be used by the server node to identify how many client nodes have been participating in the over-the-air transmission.

Therefore, in some aspects, each client node 300a:300K obtains a signature sequence and information on how the signature sequence should be embedded in the in the local model parameter vectors. Hence, in some embodiments, the server node 200 is configured to perform (optional) actions S102, S104, S106.

S102: The server node 200 obtains one signature sequence per each of the client nodes 300a:300K.

S104: The server node 200 transmits the signature sequences to the respective client nodes 300a:300K.

S106: The server node 200 transmits instructions to the client nodes 300a:300K to embed the signature sequence in the local model parameter vectors that are transmitted to the server node 200.

Actions S102, S104, S106 need not to be performed per each iteration round.

In some examples, the local model parameter vectors plus the signature sequences are mapped onto resource elements (REs) using a linear mapping. For example, suppose that each local model parameter vector has length N and that the signature sequence has length M. Then a linear transform T (e.g., represented by a matrix of dimension (N+M)×(N+M)) can be used such that what is transmitted over M+N REs is equal to T multiplied by the (M+N)-vector comprising the local model parameter vector stacked on top of the signature sequence. The matrix T can be predetermined, or transmitted by the server node to all client nodes, or obtained from a lookup table (by using an integer as index). In either case, the same matrix T should be used by all client nodes. in some examples, the matrix T is invertible and well-conditioned; for example, it can be orthonormal or constructed from a permutation.

In some examples, the explicit signature sequence is transmitted by the server node 200. In some examples, the server node 200 transmits an integer that is used as index for the client nodes 30a:300K to fetch the signature sequence from a pre-determined table of signature sequences. In some examples, the signature sequence is initiated via common information (CI) between the server node 200 and the client nodes 300a:300K. In this way, the server node 200 might provide a seed to the client nodes 300a:300K and based on this seed each of the client nodes might then generate its own signature sequence (which is also known to the server node 200). As an illustrative example, the CI might comprise a time reference, a SIB9 information in NR, a resource indication, control information, and a Radio Network Temporary Identifier (RNTI). The time reference can e.g. be related to the system frame number and/or (radio) frame and/or subframe and/or slot, and/or symbol(s) in which the assurance request is transmitted, or to another point in time, e.g. when the assurance response is granted for transmission. The time reference may also relate to an absolute time reference known in the network by e.g. use of system information. The resource indication can e.g. be one or more indices related to where in the overall time-frequency resource grid that the assurance request is transmitted, or where the response is granted. In NR such resource indication could relate to common or physical resource block (PRB) indices. The control information might comprise parts of or the whole control information received in the control message requesting the assurance request. The RNTI is generally used to differentiate/identify a connected mode agent in the cell, or a group of agents.

Further aspects of how the signature sequences might be generated, e.g. by the server node, will be disclosed next.

In general terms, the signature sequences should have zero or low cross-correlations so that the server node is capable of detecting if a certain signature sequence is present or not. In this way the server node can determine whether a local model parameter vector was received from a certain client node or not. One example is a constant-amplitude-zero-autocorrelation waveform such as Zadoff-Chu sequence.

More fundamentally, let {Sᵢ} be a family of signature sequences, indexed by i, and of length M. The received M-vector, comprising the superposition of all local model parameter vectors (with embedded signature sequences) sent by the active client nodes equals

y=Σ_{i∈U}aᵢSᵢ+w

where U is the set of client nodes actually transmitting, at are amplitude scale factors that depend on the transmission channel and on the power control per client node, and w is noise. An energy detector at the server node computes

$$\vert {S}_{j}^{H} y \vert$$

for all j, and the result can be compared to a threshold in order to detect whether client node j was active (hence belongs to U) or not. Consider

$$\vert {S}_{j}^{H} y \vert = \vert {\sum }_{i ∈ U} {a}_{i} {S}_{j}^{H} {S}_{i} + {w}^{′} \vert$$

where w′ is processed noise. Ideally,

$$\vert {S}_{j}^{H} y \vert$$

should contain only contributions from client node j (when it is active). Hence, it can be concluded that

$${S}_{j}^{H} {S}_{i}$$

should be small in magnitude for i≠j (i.e. for different client nodes). Sequences {Sᵢ} that have this property include (in addition to Zadoff-Chu): columns of an identity matrix, columns of a discrete Fourier transform matrix, and columns of a Hadamard matrix, to just name a few.

In some examples, the client nodes are instructed to divide the local model parameter vectors into several parts where each part is transmitted independently. In this case, each client node might embed a signature sequence to each of the subsets prior to transmission. Hence, in some embodiments, according to the instructions, whenever transmission of the local model parameter vector needs to be divided over two or more timeslots per iteration round, each of the client nodes 300a:300K is to embed one and the same signature sequence with the local model parameters of the local model parameter vector as transmitted in each of the two or more timeslots.

In some examples, the client nodes are instructed to use different signature sequences for different subsets. Hence, in some embodiments, according to the instructions, whenever transmission of the local model parameter vector needs to be divided over two or more timeslots per iteration round, each of the client nodes 300a:300K is to embed a different signature sequence with the local model parameters of the local model parameter vector as transmitted in each of the two or more timeslots.

In other embodiments, the signature sequences used for each subset of the data vector are the same. Any combinations of those alternatives are also possible.

In some examples, the division of the local model parameter vectors into parts can be based on a prioritization. For instance, based on principal component analysis, the most significant components of each local model parameter vector can be grouped into one category.

In some examples, the transmissions of the local model parameter vector are subject to LBT. In this case, any transmission of a local model parameter vector, or any parts of the local model parameter vector in case the local model parameter vector is divided into parts, will take place only if the client node determines that the channel is free.

In some examples, the placement of signature sequences can be different for different subsets. Specifically, if a matrix T is used as described above, a different matrix T can be used for each part (but where the same set of matrices T is used in the same way for all simultaneously transmitting client nodes).

As noted above, the server node can use the embedded signature sequences to identify the number of participating client nodes. Therefore, in some embodiments, the server node 200 is configured to perform (optional) action S120.

S120: The server node 200 determines from how many of the client nodes 300a:300K the local model parameter vectors were received for the iteration round by extracting the signature sequences from the local model parameter vectors received for the iteration round.

The server node 200, upon reception of the aggregated model parameter vectors, might decompose the received aggregated model parameter vectors into two parts: (i) the signature part, S, and (ii) the data part, D. In case a transform T is used as above, this decomposition entails the application of the matrix inverse T⁻¹. The server node then computes the correlation between S, and each Sⱼ. If the magnitude of the correlation exceeds certain threshold for each signature sequence, the server node determines that a contribution is present from client node j. The data vector D can then be scaled based on the number of identified client nodes for model aggregation. Therefore, in some embodiments, the server node 200 is configured to perform (optional) action S122.

S122: The server node 200 scales a data vector comprising all the local model parameter vectors received for the iteration round in accordance with from how many of the client nodes 300a:300K the local model parameter vectors were received for the iteration round.

Steps S110-S122 can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

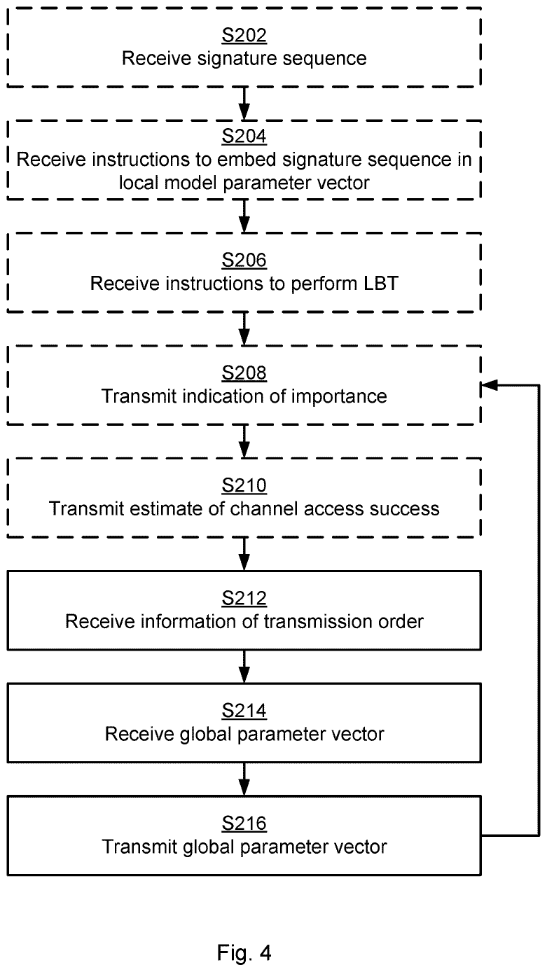

Reference is now made to FIG. 4 illustrating a method as performed by a client node 300k for performing a federated iterative learning process with a server node 200 according to an embodiment. Per each iteration round of the federated iterative learning process, the client node 300k is configured to transmit a local model parameter vector with locally computed computational results to the server node 200. A set of timeslots are available for the transmission of the local model parameter vector. Actions as taken by the client node 300k per each iteration round of the federated iterative learning process will be disclosed next

S212: The client node 300k receives information of a transmission order in which the local model parameters of the model parameter vectors are to be transmitted for the iteration round. The transmission order is based on an indication of importance per local model parameter and an estimate of channel access success per timeslot.

S214: The client node 300k receives a global parameter vector of the iteration round from the server node 200.

S216: The client node 300k transmits the local model parameter vector, as determined based on the global parameter vector and local data, for the iteration round to the server node 200 in at least one of the timeslots, wherein the local model parameters of the local model parameter vector are transmitted in accordance with the transmission order.

Embodiments relating to further details of performing a federated iterative learning process as performed by the client node 300k will now be disclosed with continued reference to FIG. 4.

As disclosed above, in some embodiments, the local model parameter vector is transmitted over-the-air and using analog linear modulation.

As disclosed above, in some examples, the most important parameters are mapped to timeslots where channel access success is highest. Therefore, according to some embodiments, according to the transmission order, the local model parameters with highest importance are be transmitted in the timeslots with estimated highest channel access success.

As disclosed above, in some examples, the indication of importance is provided by one or more of the client nodes 300a:300K. Therefore, in some embodiments, the client node 300k is configured to perform (optional) action S208.

S208: The client node 300k transmits the indication of the importance per local model parameter of the local model parameter vector for the iteration round to the server node 200.

As disclosed above, in some examples, one or more of the client nodes 300a:300K are configured to measure the output variation and associated accuracy, or loss impact, when performing perturbations of the local model parameters. That is, in some embodiments, the client node 300k determines the indication of importance by estimating sensitivity of the local model parameters to perturbation, and wherein the higher the sensitivity, the higher the importance is.

As disclosed above, in some examples, the importance score can be based on the magnitude of the local model parameters. That is, in some embodiments, the client node 300k determines the indication of importance by estimating magnitude per each of the local model parameters, and wherein the lower the magnitude, the higher the importance is.

As disclosed above, in some examples, an estimate of channel access success is provided by one or more of the client nodes 300a:300K. Therefore, in some embodiments, the client node 300k is configured to perform (optional) action S210.

S210: The client node 300k transmits the estimate of channel access success per timeslot for the iteration round to the server node 200.

As disclosed above, the client nodes 300a:300K might estimate the probability of success for LBT in a certain timeslot, based on historical information of the client transmissions. Therefore, in some embodiments, the client node 300k determines the estimate of channel access success per timeslot based on successful transmission of previous transmissions of local model parameter vector to the server node 200.

As disclosed above, in some examples, the client nodes 300a:300K are configured to in each timeslot contend for the channel using LBT and thus the transmissions of the local model parameters are subject to an LBT procedure. Therefore, in some embodiments, the client node 300k is configured to perform (optional) action S206.

S206: The client node 300k receives instructions from the server node 200 that the client node 300k is to perform a listen-before-talk procedure for each timeslot in which any local model parameter of the local model parameter vector is to be transmitted.

Actions S206 needs not to be performed per each iteration round.

As disclosed above, the server node might instruct the client nodes 300a:300K to embed a signature sequence in each local model parameter vector. Therefore, in some embodiments, the client node 300k is configured to perform (optional) actions S202, S204.

S202: The client node 300k receives a signature sequence from the server node 200;

S204: The client node 300k receives instructions from the server node 200 to embed the signature sequence in the local model parameter vector. The signature sequence is then embedded in the local model parameter vector that is transmitted to the server node 200.

Actions S202, S204 need not to be performed per each iteration round, except for the client node 300k to embed the signature sequence in the local model parameter vector that is transmitted to the server node 200 in S216.

In some examples, the signature sequences are inserted at the beginning of the local model parameter vector. In some examples, the signature sequences are inserted at the end of the local model parameter vector. In some examples, the signature sequences are inserted somewhere between the beginning and the end of the local model parameter vector. As noted above, the signature sequences are different for different client nodes but the way they are embedded are the same for all client nodes.

As disclosed above, the client nodes might be instructed to divide the local model parameter vectors into several parts where each part is transmitted independently, and then embed a signature sequence to each of the subsets prior to transmission. Therefore, in some embodiments, according to the instructions, whenever transmission of the local model parameter vector needs to be divided over two or more timeslots per iteration round, the client node 300k embeds one and the same signature sequence with the local model parameters of the local model parameter vector as transmitted in each of the two or more timeslots.

As disclosed above, the client nodes might be instructed to use different signature sequences for different subsets. Therefore, in some embodiments, according to the instructions, whenever transmission of the local model parameter vector needs to be divided over two or more timeslots per iteration round, the client node 300k embeds a different signature sequence with the local model parameters of the local model parameter vector as transmitted in each of the two or more timeslots.

Steps S208-S216 can be repeated until a termination criterion is met. The termination criterion in some non-limiting examples can be when a pre-determined number of iterations have been reached, when an aggregated loss function has reached a desired value, or when the aggregated loss function does not decrease after one (or several round) of iterations. The loss function itself represents a prediction error, such as mean square error or mean absolute error.

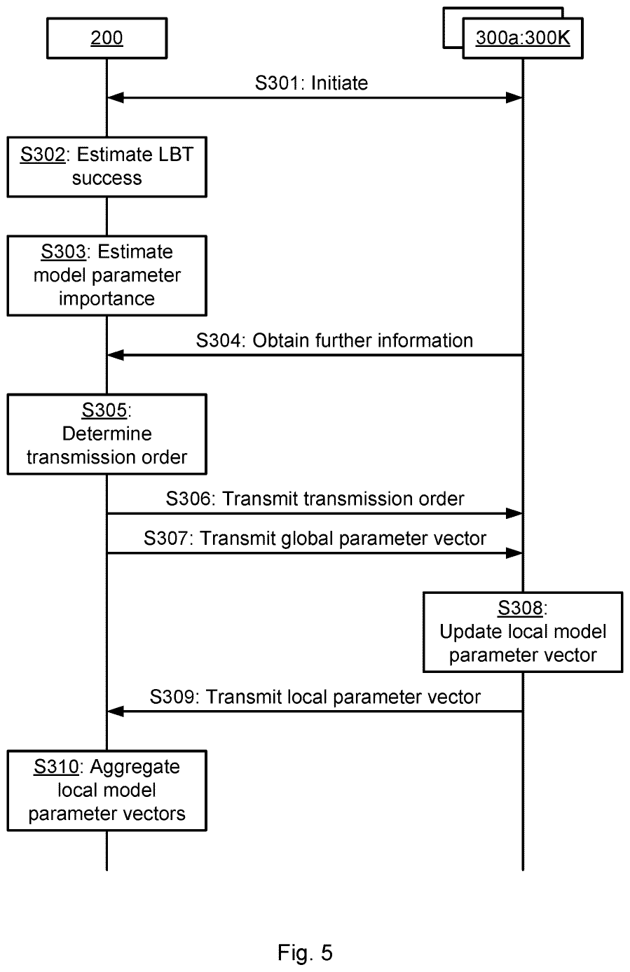

One particular embodiment for performing a federated iterative learning process will be disclosed next with reference to the signaling diagram of FIG. 5.

S301: Initiate; the federated iterative learning process is initiated between the server node and the client nodes. In some examples, the client nodes are configured with a computational task to be performed by the client nodes. In some examples, the client nodes report their dataset importance to the server node. In some examples, the client nodes are instructed to perform an LBT procedure for each timeslot in which any local model parameter of the local model parameter vector is to be transmitted.

S302: Estimate LBT success; the server node obtains an estimate of the channel access success per timeslot in a set of N timeslots available for each iteration of the federated learning process, as in S110. The channel access success per timeslot might be estimated by the server node 200 alone, by the server node 200 in collaboration with one or more of the client nodes 300a:300K, or by one or more of the client nodes 300a:300K alone.

S303: Estimate model parameter importance; the server node obtains an indication of importance per local model parameter of the model parameter vectors, as in S110. The model parameter importance might be determined by the server node 200 alone, by the server node 200 in collaboration with one or more of the client nodes 300a:300K, or by one or more of the client nodes 300a:300K alone.

S304: Obtain further information (optional); the server node optionally obtains further information, such as information about other RATs operating in the same unlicensed band, the dataset importance per at least one of the client nodes.

S305: Determine transmission order; the server node determines, based on the acquired information, a transmission order in which the local model parameters of the model parameter vectors are to be transmitted for the iteration round.

S306: Transmit transmission order; the server node transmits information of the transmission order to the client nodes.

S307: Transmit global parameter vector; the server node transmits its global parameter vector of the iteration round to the client nodes.

S308: Update local model parameter vector; each of the client nodes updates their local model parameter vector based on the global parameter vector and local data, for the iteration round.

S309: Transmit local model parameter vector; each of the client nodes at least attempts to transmit the updated local model parameter vector to the server node in at least one of the timeslots. The local model parameters of the local model parameter vector are transmitted in accordance with the transmission order. In some examples, the transmission is based on LBT.

S310: Aggregate local model parameter vectors; the server node updates its estimate of the global parameter vector based on an aggregation of the received local model parameter vectors.

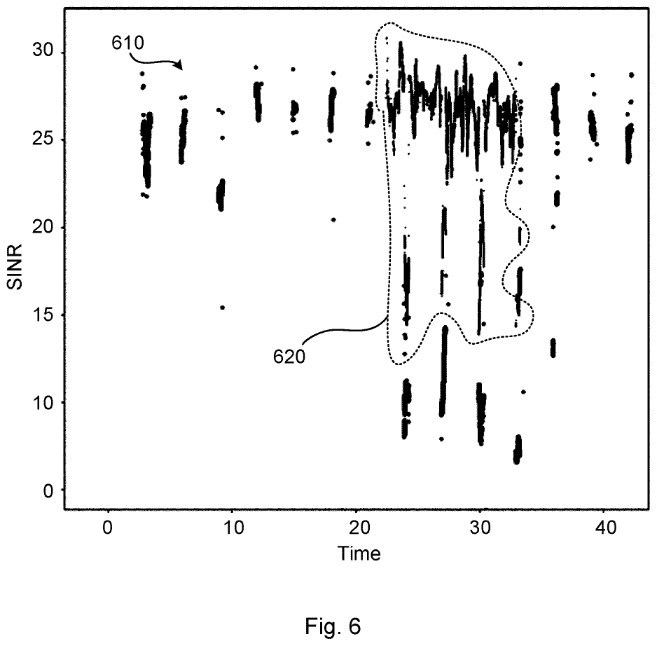

As disclosed above, in some examples, the server node requests the client nodes to estimate the probability of LBT success. The client nodes can estimate this based on observed interference (energy) in the vicinity. The interference can in some occasions be periodic. In this respect, in some situations, user equipment can experience predictable traffic in case an interferer has a certain traffic pattern, such as video-call streaming or periodic sensor data transmissions. The traffic in two cells is exemplified in FIG. 6, where the signal to interference plus noise ratio (SINR) is shown as function of time for two user equipment (UE1 and UE2). UE1 has periodic video streaming traffic starting at t=3 seconds, and UE2 receives a file transfer download starting at t=23 seconds. The SINR for UE1 is shown in the general part 610 of FIG. 6 (from t=3 seconds to t=42 seconds) and the SINR for UE2 is shown in the encircled part 620 (from t=23 seconds to t=32 seconds). As shown in FIG. 6, the SINR for UE1 and UE2 varies depending on whether their traffic is colliding or not. Specifically, the SINR for UE1 drops significantly during the file transfer for UE2, but also the SINR for UE2 varies, due to the video streaming traffic to UE1. It is assumed that LBT is carried out in this example, but the SINR is still heavily impacted as shown in the figure. Similarly, according to embodiments disclosed herein each user equipment can observe the traffic from another user equipment in the vicinity to estimate the probability of success of channel access in a certain timeslot. In the example shown in FIG. 6, UE2 can observe the traffic from UE1 (and vice versa), and estimate the timeslots where traffic will occur from UE1. The client nodes can then, for example, report to the server node according to the LBT success probability illustrated in Table 1:

TABLE 1
LBT success probability per timeslot.

| Timeslot | 1 | 2 | 3 | 4 |
|---|---|---|---|---|
| UE1 likeliness of empty | 0.8 | 0.99 | 0.99 | 0.5 |
| UE2 likeliness of empty | 0.8 | 0.99 | 0.8 | 0.5 |

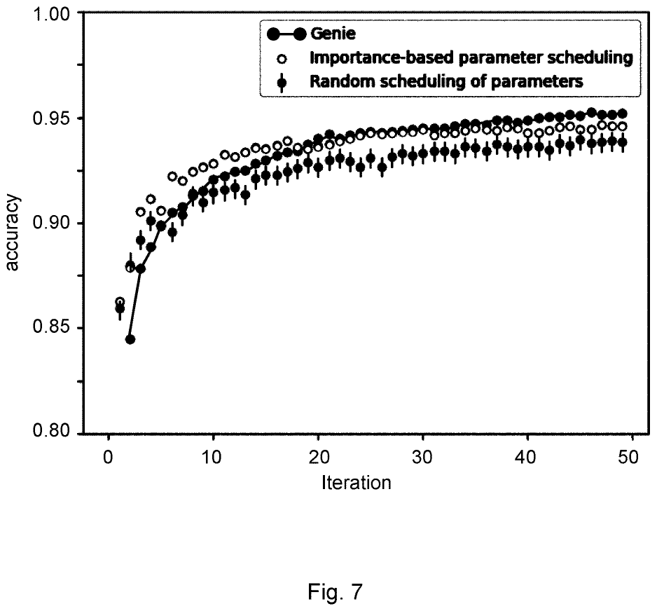

Simulation results will be disclosed next with reference to FIG. 7. In this illustrative example, 10 client nodes are to participate in a federated iterative learning process. using LBT. Due to this, it is assumed that for a given timeslot only a subset of the client nodes can participate in the transmission of all local model parameters. Using the herein disclosed embodiments, the server node takes into account the likeliness of client nodes that cannot participate in transmissions of a subset of the local model parameters, to increase the likeliness that important local model parameters are aggregated over-the-air. In the evaluated scenario, the model parameter importance is decided based on the magnitude of the model parameter, where large-valued parameters are expected to impact the activation functions to a larger extent. In FIG. 7 is illustrated the results of three different scenarios; genie, importance-based scheduling, and random scheduling. In the genie scenario, all client nodes transmit all local model parameters. In the importance-based scheduling scenario, 50% of the model parameters with the largest absolute value are aggregated for all client nodes, the other half are only transmitted by a single client node. In the random scheduling scenario, a random selection of 50% of the model parameters (regardless of absolute values) are aggregated for all client nodes, and the other half are only transmitted by a single client node. The random scheduling scenario would be the baseline scenario if no prioritization of model parameters is performed. The results show that aggregating certain model parameters, as constrained by LBT limitations, can impact the overall performance.

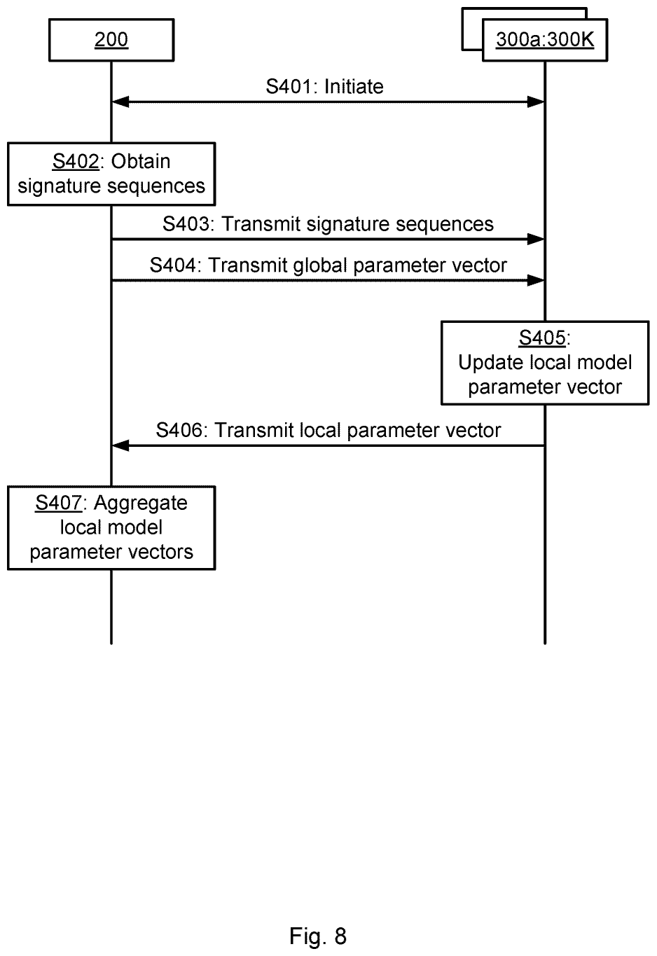

One particular embodiment for performing a federated iterative learning process will be disclosed next with reference to the signaling diagram of FIG. 8.

S401: Initiate; the federated iterative learning process is initiated between the server node and the client nodes. In some examples, the client nodes are configured with a computational task to be performed by the client nodes. In some examples, the client nodes report their dataset importance to the server node. In some examples, the client nodes are instructed to perform an LBT procedure for each timeslot in which any local model parameter of the local model parameter vector is to be transmitted.

S402: Obtain signature sequence; the server node obtains one signature sequence per each of the client nodes.

S403: Transmit signature sequence; the server node transmits the signature sequences to the client nodes. The server node also transmits instructions to the client nodes to embed the signature sequence in the local model parameter vectors that are transmitted to the server node.

S404: Transmit global parameter vector; the server node transmits its global parameter vector of the iteration round to the client nodes.

S405: Update local model parameter vector; each of the client nodes updates their local model parameter vector based on the global parameter vector and local data, for the iteration round. The client nodes embed the signature sequence in the local model parameter vector that is to be transmitted to the server node.

S406: Transmit local model parameter vector; each of the client nodes at least attempts to transmit the updated local model parameter vector (with the embedded signature sequence) to the server node in at least one timeslot in a set of available of timeslots. Optionally, the local model parameters of the local model parameter vector are transmitted in accordance with a transmission order as determined by the server node. In some examples, the transmission is based on LBT.

S407: Aggregate local model parameter vectors; the server node updates its estimate of the global parameter vector based on an aggregation of the received local model parameter vectors. The server node can determine from how many of the client nodes the local model parameter vectors were received for the iteration round by extracting the signature sequences from the local model parameter vectors received for the iteration round. The server node can then scale a data vector comprising all the local model parameter vectors received for the iteration round in accordance with from how many of the client nodes the local model parameter vectors were received for the iteration round.

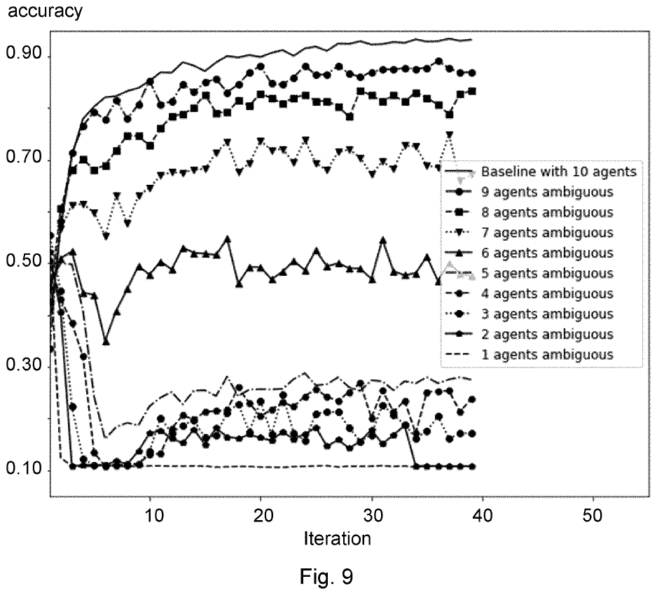

Simulation results will be disclosed next with reference to FIGS. 9, 10, and 11. The simulation results represents an example where federated iterative learning with ten participating client nodes was used to train a machine-learning model for performing digit classification using the Modified National Institute of Standards and Technology (MNIST). The classifier comprises a feed-forward neural network. The model input is an image represented by 784 values, and each client node is configured with 1000-digit images for training and another set of 1000 images for testing. In FIG. 9 is shown the effect on the performance caused by having an unknown number of participating client nodes. In this figure, the local model parameter vectors were by the server node received for a varying number of client nodes, where the server node, due to lack of prior information, assumes that it has received local model parameter vectors from all the client nodes. This results in an incorrect model aggregation. The figure shows the test accuracy for 40 iteration rounds for one random setup. As can be seen, as the number of client nodes that were not capable of sending their model updates (due to LBT for example) increases, the test accuracy decreases. As can be seen, for the present example, if more than two client nodes are absent, the accuracy of the trained model will drop to below 50%, making it practically not usable.

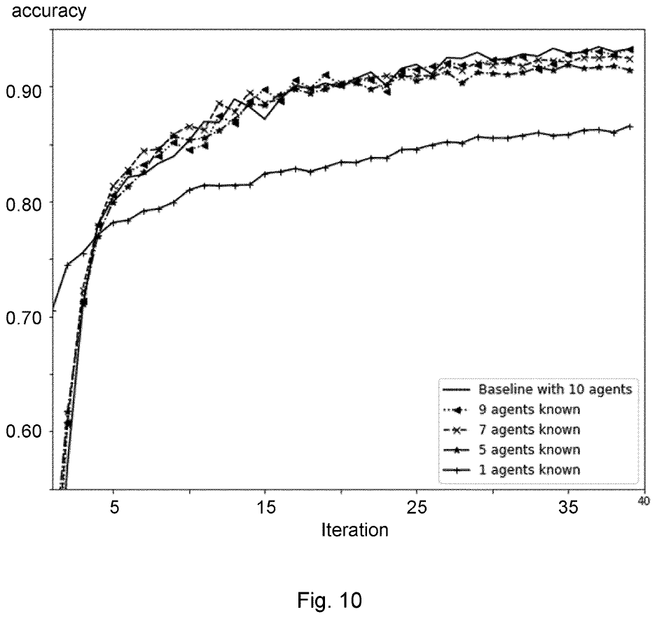

On the other hand, if the server node knew the number of participating client nodes, the serve node could perform the averaging correctly (based on the correct number of participating client nodes). This is illustrated in FIG. 10, which is based on the same setup as in FIG. 9, but with the server node having the correct assumption regarding the number of participating client node when performing the federated averaging. As can be seen, the performance is almost on par with the baseline model where local model parameter vectors from all client nodes are received.

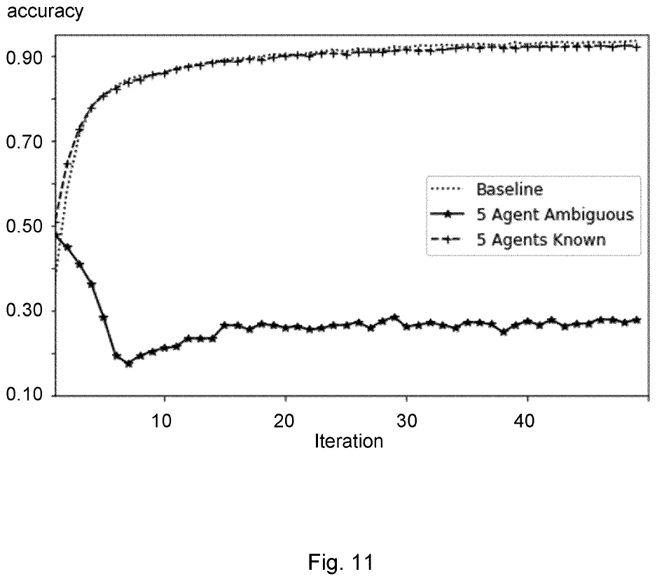

in FIG. 11 is shown the average test accuracy as a function of iteration round for three cases for a federated iterative learning example with ten participating client nodes for three different scenarios. In a baseline scenario the server node receives model parameter vectors from all agents. In a scenario denoted “5 agents ambiguous” the server node receives model parameter vectors from only five client nodes but assumes that the model parameter vectors have been received from all client nodes. In a scenario denoted “5 agents known” the server node receives model parameter vectors from only five client nodes and is able to detects this (i.e. that only five client nodes were able to send their model parameter vectors. As can be seen, when the server node knows how many client nodes have participated in each iteration round, the server node can correctly perform the averaging, which results in an average test accuracy very close to the baseline.

Non-limiting examples of scenarios where the herein disclosed embodiments can be applied will be disclosed next.

According to a first example, the computational task pertains to prediction of best secondary carrier frequencies to be used by user equipment 170a: 170K in which the client nodes 300a:300K are provided. The data locally obtained by the client node 300k can then represent a measurement on a serving carrier of the user equipment 170k. In this respect, the best secondary carrier frequencies for user equipment 170a: 170K can be predicted based on their measurement reports on the serving carrier. The secondary carrier frequencies as reported thus defines the computational result. In order to enable such a mechanism, the client nodes 300a:300K can be trained by the server node 200, where each client node 300k, according to the machine learning model, takes as input the measurement reports on the serving carrier(s) (among possibly other available reports such as timing advance, etc.) and as outputs a prediction of whether the user equipment 170k in which the client node 300k is provided has coverage or not in the secondary carrier frequency.

According to a second example, the computational task pertains to compressing channel-state-information using an auto-encoder, where the server node 200 implements a decoder of the auto-encoder, and where each of the client nodes 300a:300K, according to the machine learning model, implements a respective encoder of the auto-encoder. An autoencoder can be regarded as a type of neural network used to learn efficient data representations.

According to a third example, the computational task pertains to signal quality drop prediction. The signal quality drop prediction is based on measurements on wireless links used by user equipment 170a: 170K in which the client nodes 300a:300K are provided. In this respect, based on received data, in terms of computational results, in the reports, the server node 200 can learn, for example, what sequence of signal quality measurements (e.g., reference signal received power; RSRP) that results in a large signal quality drop. After a machine learning model is trained, for instance using the iterative learning process, the server node 200 can provide the model to the client nodes 300a:300K. The model can be provided either to client nodes 300a:300K having taken part in the training, or to other client nodes 300a:300K. The client nodes 300a:300K can then apply the model to predict future signal quality values. This signal quality prediction can then be used in the context of any of: initiating inter-frequency handover, setting handover and/or reselection parameters, changing device scheduler priority so as to schedule the user equipment 170a: 170K when the expected signal quality is good. The data for training such a model is located at the device-side where the client nodes 300a:300K reside, and hence an iterative learning process as disclosed herein can be used to efficiently learn the future signal quality prediction.

According to a fourth example, the iterative learning procedure concerns mapping one or more geolocations to a radio signal quality values, or bitrate values. This can be used by the network to create an understanding of potential network coverage holes in a cell, and how the bitrate varies within the cell. However, a device-reported geolocation can violate privacy concerns of the user equipment, and therefore an iterative learning procedure can be used since it only comprises signaling of parameter vectors. As an illustrative example assume that client nodes 300a:300K have a dataset of geolocation to Signal-to-Interference-plus-Noise Ratio (SINR) mappings according to each respective dotted area (where the SINR takes a normalized value from 0 to 1). The client nodes 300a:300K then perform an iterative learning procedure with the server node 200 in order to include their dataset information in a global machine learning model to be used by the network.

According to a fifth example, the iterative learning procedure concerns surveillance, using a network of cameras, of a particular area public or private). Each camera is associated with its own client node 300a:300K. The network is configured to learn a global machine learning model that can be used to detect whether suspicious activity is ongoing in any of the video imagery as captured by the cameras. The suspicious activity could pertain to identifying unauthorized persons present in a private area, identifying vehicles in the area, or monitoring the area for any criminal activity. The cameras however, for privacy reasons, are not allowed to share their raw image data. An iterative learning procedure can then be used to train the global machine learning model, where the cameras share only model (gradient) updates in terms of parameter vectors, rather than their observations. In this case the parameter vectors might represent predictions of the content in the images (for examples, parameters of a face recognition algorithm).

According to a sixth example, the iterative learning procedure concerns a natural language processing application. The client nodes 300a:300K could learn a language model that represents a machine learning model, for example for text prediction when typing on a user equipment 170a: 170K, such as a mobile device, where each of the client nodes 300a:300K thus could be associated with their own user equipment 170a: 170K. Using an iterative learning procedure, only updates to the model need to be shared, but raw text data will not be shared.

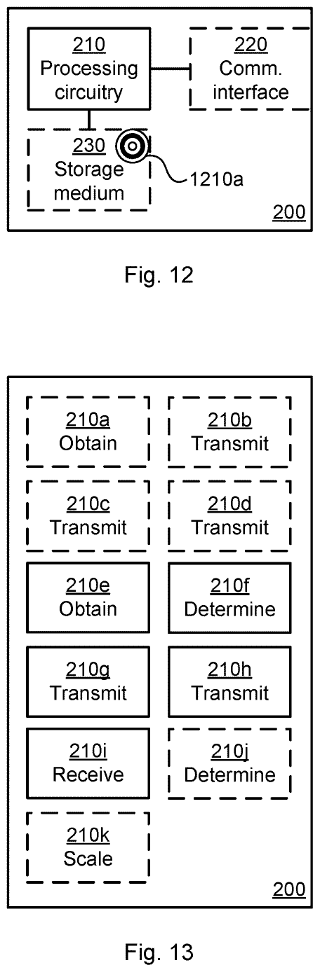

FIG. 12 schematically illustrates, in terms of a number of functional units, the components of a server node 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1610a (as in FIG. 16), e.g. in the form of a storage medium 230. The processing circuitry 210 may further be provided as at least one application specific integrated circuit (ASIC), or field programmable gate array (FPGA).

Particularly, the processing circuitry 210 is configured to cause the server node 200 to perform a set of operations, or steps, as disclosed above. For example, the storage medium 230 may store the set of operations, and the processing circuitry 210 may be configured to retrieve the set of operations from the storage medium 230 to cause the server node 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The server node 200 may further comprise a communications (comm.) interface 220 for communications with other entities, functions, nodes, and devices, either directly or indirectly. As such the communications interface 220 may comprise one or more transmitters and receivers, comprising analogue and digital components.

The processing circuitry 210 controls the general operation of the server node 200 e.g. by sending data and control signals to the communications interface 220 and the storage medium 230, by receiving data and reports from the communications interface 220, and by retrieving data and instructions from the storage medium 230. Other components, as well as the related functionality, of the server node 200 are omitted in order not to obscure the concepts presented herein.

FIG. 13 schematically illustrates, in terms of a number of functional modules, the components of a server node 200 according to an embodiment. The server node 200 of FIG. 13 comprises a number of functional modules; an obtain module configured to perform step S110, a determine module configured to perform step S112, a transmit module configured to perform step S114, a transmit module configured to perform step S116, and a receive module configured to perform step S118. The server node 200 of FIG. 13 may further comprise a number of optional functional modules, such as any of an obtain module configured to perform step S102, a transmit module configured to perform step S104, a transmit module configured to perform step S106, a transmit module configured to perform step S108, a determine module configured to perform step S120, and a scale module configured to perform step S122.

In general terms, each functional module 210a: 210k may be implemented in hardware or in software. Preferably, one or more or all functional modules 210a: 210k may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210k and to execute these instructions, thereby performing any steps of the server node 200 as disclosed herein.

The server node 200 may be provided as a standalone device or as a part of at least one further device. For example, the server node 200 may be provided in a node of the radio access network or in a node of the core network. Alternatively, functionality of the server node 200 may be distributed between at least two devices, or nodes. These at least two nodes, or devices, may either be part of the same network part (such as the radio access network or the core network) or may be spread between at least two such network parts. In general terms, instructions that are required to be performed in real time may be performed in a device, or node, operatively closer to the cell than instructions that are not required to be performed in real time. Thus, a first portion of the instructions performed by the server node 200 may be executed in a first device, and a second portion of the instructions performed by the server node 200 may be executed in a second device; the herein disclosed embodiments are not limited to any particular number of devices on which the instructions performed by the server node 200 may be executed. Hence, the methods according to the herein disclosed embodiments are suitable to be performed by a server node 200 residing in a cloud computational environment. Therefore, although a single processing circuitry 210 is illustrated in FIG. 12 the processing circuitry 210 may be distributed among a plurality of devices, or nodes. The same applies to the functional modules 210a: 210k of FIG. 13 and the computer program 1620a of FIG. 16.

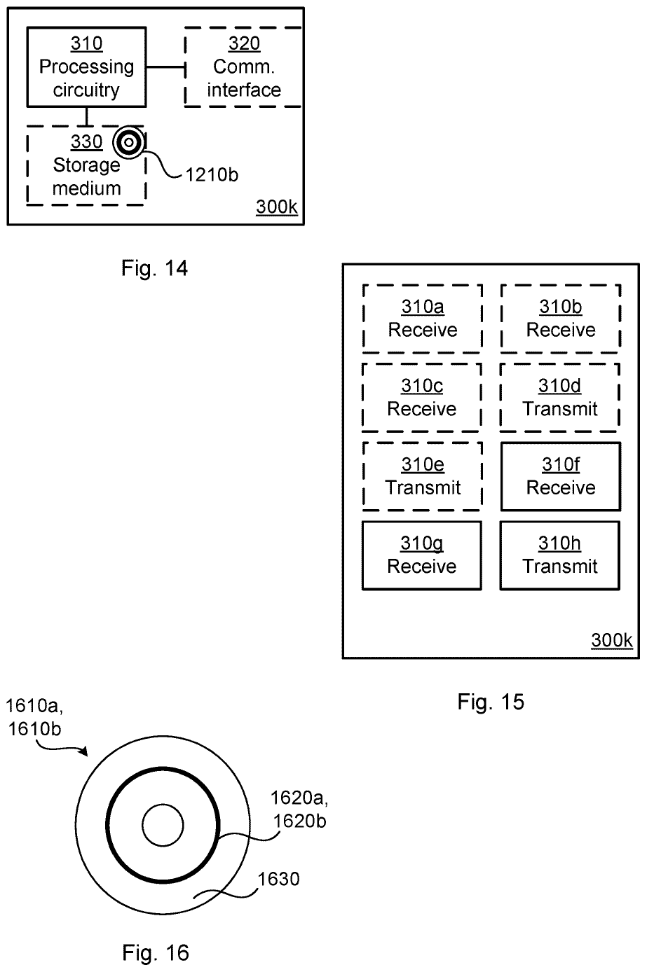

FIG. 14 schematically illustrates, in terms of a number of functional units, the components of a client node 300k according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1610b (as in FIG. 16), e.g. in the form of a storage medium 330. The processing circuitry 310 may further be provided as at least one application specific integrated circuit (ASIC), or field programmable gate array (FPGA).

Particularly, the processing circuitry 310 is configured to cause the client node 300k to perform a set of operations, or steps, as disclosed above. For example, the storage medium 330 may store the set of operations, and the processing circuitry 310 may be configured to retrieve the set of operations from the storage medium 330 to cause the client node 300k to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The client node 300k may further comprise a communications interface 320 for communications with other entities, functions, nodes, and devices, either directly or indirectly. As such the communications interface 320 may comprise one or more transmitters and receivers, comprising analogue and digital components.

The processing circuitry 310 controls the general operation of the client node 300k e.g. by sending data and control signals to the communications interface 320 and the storage medium 330, by receiving data and reports from the communications interface 320, and by retrieving data and instructions from the storage medium 330.

Other components, as well as the related functionality, of the client node 300k are omitted in order not to obscure the concepts presented herein.

FIG. 15 schematically illustrates, in terms of a number of functional modules, the components of a client node 300k according to an embodiment. The client node 300k of FIG. 15 comprises a number of functional modules; a receive module configured to perform step S212, a receive module configured to perform step S214, and a transmit module configured to perform step S216. The client node 300k of FIG. 15 may further comprise a number of optional functional modules, such as any of a receive module configured to perform step S202, a receive module configured to perform step S204, a receive module configured to perform step S206, a transmit module configured to perform step S208, and a transmit module configured to perform step S210.

In general terms, each functional module 310a:310h may be implemented in hardware or in software. Preferably, one or more or all functional modules 310ₐ:310h may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310h and to execute these instructions, thereby performing any steps of the client node 300k as disclosed herein.

FIG. 16 shows one example of a computer program product 1610a, 1610b comprising computer readable means 1630. On this computer readable means 1630, a computer program 1620a can be stored, which computer program 1620a can cause the processing circuitry 210 and thereto operatively coupled entities and devices, such as the communications interface 220 and the storage medium 230, to execute methods according to embodiments described herein. The computer program 1620a and/or computer program product 1610a may thus provide means for performing any steps of the server node 200 as herein disclosed. On this computer readable means 1630, a computer program 1620b can be stored, which computer program 1620b can cause the processing circuitry 310 and thereto operatively coupled entities and devices, such as the communications interface 320 and the storage medium 330, to execute methods according to embodiments described herein. The computer program 1620b and/or computer program product 1610b may thus provide means for performing any steps of the client node 300k as herein disclosed.

In the example of FIG. 16, the computer program product 1610a, 1610b is illustrated as an optical disc, such as a CD (compact disc) or a DVD (digital versatile disc) or a Blu-Ray disc. The computer program product 1610a, 1610b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1620a, 1620b is here schematically shown as a track on the depicted optical disk, the computer program 1620a, 1620b can be stored in any way which is suitable for the computer program product 1610a, 1610b.

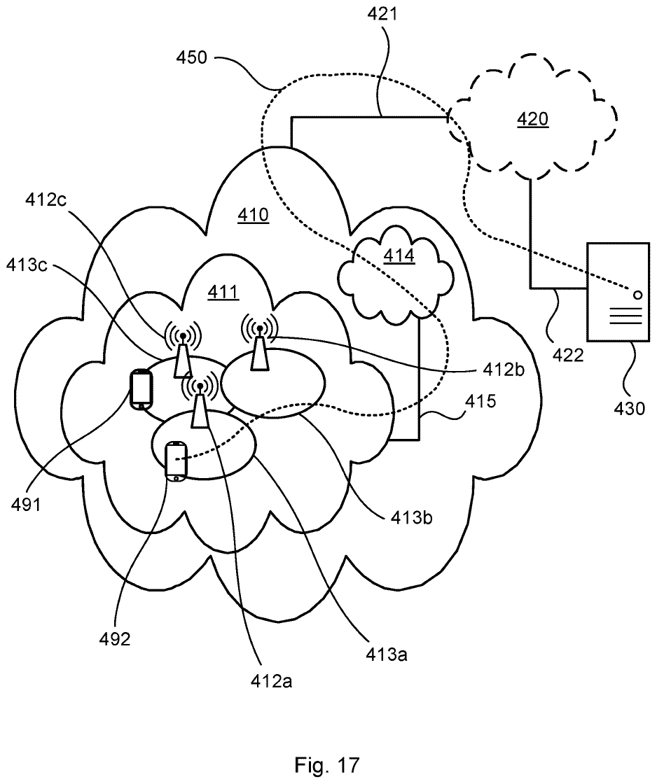

FIG. 17 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as radio access network 110 in FIG. 1, and core network 414, such as core network 120 in FIG. 1. Access network 411 comprises a plurality of radio access network nodes 412a, 412b, 412c, such as NBs, eNBs, gNBs (each corresponding to the network node 160 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412. The UEs 491, 492 correspond to the user equipment 170a, 170b, . . . , 170K of FIG. 1.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 17 as a whole enables connectivity between the connected UEs 491, 492 and host computer 430. The connectivity may be described as an over-the-top (OTT) connection 450. Host computer 430 and the connected UEs 491, 492 are configured to communicate data and/or signalling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

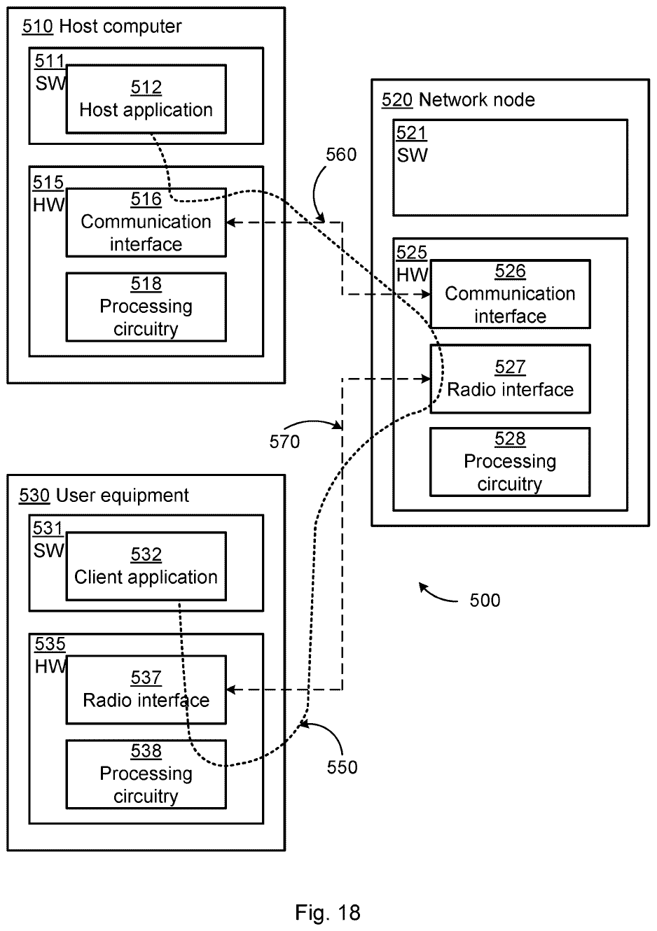

FIG. 18 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 18. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. The UE 530 corresponds to the user equipment 170a, 170b, . . . , 170K of FIG. 1. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the network node 160 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 18) served by radio access network node 520. Communication interface 526 may be configured to facilitate connection 560 to host computer 510. Connection 560 may be direct or it may pass through a core network (not shown in FIG. 18) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 18 may be similar or identical to host computer 430, one of network nodes 412a, 412b, 412c and one of UEs 491, 492 of FIG. 17, respectively. This is to say, the inner workings of these entities may be as shown in FIG. 18 and independently, the surrounding network topology may be that of FIG. 17.

In FIG. 18, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signalling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for performing a federated iterative learning process with client nodes, wherein the method is performed by a server node, wherein per each iteration round of the federated iterative learning process, each of the client nodes are configured to transmit a local model parameter vector with locally computed computational results to the server node, wherein a set of timeslots are available for the transmission of the local model parameter vector, and wherein the method per each iteration round comprises:
obtaining an indication of importance per local model parameter of the model parameter vectors and an estimate of channel access success per timeslot in the set of timeslots;
determining, based on the indication of importance per local model parameter and the estimate of channel access success per timeslot, a transmission order in which the local model parameters of the model parameter vectors are to be transmitted for the iteration round;
transmitting information of the transmission order to the client nodes;
transmitting a global parameter vector of the iteration round to the client nodes; and
receiving local model parameter vectors from the client nodes in at least one of the timeslots.

2-3. (canceled)

4. The method according to claim 1, wherein the server node determines the indication of importance by estimating sensitivity of the local model parameters to perturbation, and wherein the higher the sensitivity, the higher the importance is.

5. The method according to claim 1, wherein the server node determines the indication of importance by estimating magnitude per each of the local model parameters, and wherein the lower the magnitude, the higher the importance is.

6-7. (canceled)

8. The method according to claim 1, wherein the server node determines the estimate of channel access success per timeslot based on successful reception of previous transmissions of local model parameter vector from the client nodes.

9. The method according to claim 1, wherein the server node determines the estimate of channel access success per timeslot to be higher the earlier in time the timeslot occurs.

10. The method according to claim 1, wherein the server node determines the estimate of channel access success per timeslot based on radio access technologies operating within, or adjacent, a bandwidth within which the local model parameter vectors are transmitted.

11-12. (canceled)

13. The method according to claim 1, wherein the method further comprises:
transmitting instructions to the client nodes to perform a listen-before-talk procedure for each timeslot in which any local model parameter of the local model parameter vector is to be transmitted.

14. (canceled)

15. The method according to claim 1, wherein the method further comprises:
obtaining one signature sequence per each of the client nodes;
transmitting the signature sequences to the respective client nodes; and
transmitting instructions to the client nodes to embed the signature sequence in the local model parameter vectors that are transmitted to the server node.

16. The method according to claim 15, wherein, according to the instructions, whenever transmission of the local model parameter vector needs to be divided over two or more timeslots per iteration round, each of the client nodes is to embed one and the same signature sequence with the local model parameters of the local model parameter vector as transmitted in each of the two or more timeslots.

17. The method according to claim 15, wherein, according to the instructions, whenever transmission of the local model parameter vector needs to be divided over two or more timeslots per iteration round, each of the client nodes is to embed a different signature sequence with the local model parameters of the local model parameter vector as transmitted in each of the two or more timeslots.

18. The method according to claim 15, wherein the method per each iteration round further comprises:
determining from how many of the client nodes the local model parameter vectors were received for the iteration round by extracting the signature sequences from the local model parameter vectors received for the iteration round.

19. The method according to claim 18, wherein the method per each iteration round further comprises:
scaling a data vector comprising all the local model parameter vectors received for the iteration round in accordance with from how many of the client nodes the local model parameter vectors were received for the iteration round.

20. A method for performing a federated iterative learning process with a server node, wherein the method is performed by a client node, wherein per each iteration round of the federated iterative learning process, the client node is configured to transmit a local model parameter vector with locally computed computational results to the server node, wherein a set of timeslots are available for the transmission of the local model parameter vector, and wherein the method per each iteration round comprises:
receiving information of a transmission order in which the local model parameters of the model parameter vectors are to be transmitted for the iteration round, wherein the transmission order is based on an indication of importance per local model parameter and an estimate of channel access success per timeslot;
receiving a global parameter vector of the iteration round from the server node;
transmitting the local model parameter vector, as determined based on the global parameter vector and local data, for the iteration round to the server node in at least one of the timeslots, wherein the local model parameters of the local model parameter vector are transmitted in accordance with the transmission order;
transmitting the indication of the importance per local model parameter of the local model parameter vector for the iteration round to the server node; and/or
transmitting the estimate of channel access success per timeslot for the iteration round to the server node.

21-25. (canceled)

26. The method according to claim 20, wherein the client node determines the estimate of channel access success per timeslot based on successful transmission of previous transmissions of local model parameter vector to the server node.

27. The method according to claim 20, wherein the method further comprises:
receiving instructions from the server node that the client node is to perform a listen-before-talk procedure for each timeslot in which any local model parameter of the local model parameter vector is to be transmitted.

28. (canceled)

29. The method according to claim 20, wherein the method further comprises:
receiving a signature sequence from the server node;
receiving instructions from the server node to embed the signature sequence in the local model parameter vector, and wherein the signature sequence is embedded in the local model parameter vector that is transmitted to the server node.

30. The method according to claim 29, wherein, according to the instructions, whenever transmission of the local model parameter vector needs to be divided over two or more timeslots per iteration round, the client node embeds one and the same signature sequence with the local model parameters of the local model parameter vector as transmitted in each of the two or more timeslots.

31. The method according to claim 29, wherein, according to the instructions, whenever transmission of the local model parameter vector needs to be divided over two or more timeslots per iteration round, the client node embeds a different signature sequence with the local model parameters of the local model parameter vector as transmitted in each of the two or more timeslots.

32. A server node for performing a federated iterative learning process with client nodes, wherein per each iteration round of the federated iterative learning process, each of the client nodes are configured to transmit a local model parameter vector with locally computed computational results to the server node, wherein a set of timeslots are available for the transmission of the local model parameter vector, the server node comprising processing circuitry, the processing circuitry being configured to cause the server node, to, per each iteration round:
obtain an indication of importance per local model parameter of the model parameter vectors and an estimate of channel access success per timeslot in the set of timeslots;
determine, based on the indication of importance per local model parameter and the estimate of channel access success per timeslot, a transmission order in which the local model parameters of the model parameter vectors are to be transmitted for the iteration round;
transmit information of the transmission order to the client nodes;
transmit a global parameter vector of the iteration round to the client nodes; and
receive local model parameter vectors from the client nodes in at least one of the timeslots.

33-34. (canceled)

35. A client node for performing a federated iterative learning process with a server node, wherein per each iteration round of the federated iterative learning process, the client node is configured to transmit a local model parameter vector with locally computed computational results to the server node, wherein a set of timeslots are available for the transmission of the local model parameter vector, the client node comprising processing circuitry, the processing circuitry being configured to cause the client node to, per each iteration round:
receive information of a transmission order in which the local model parameters of the model parameter vectors are to be transmitted for the iteration round, wherein the transmission order is based on an indication of importance per local model parameter and an estimate of channel access success per timeslot;
receive a global parameter vector of the iteration round from the server node; and
transmit the local model parameter vector, as determined based on the global parameter vector and local data, for the iteration round to the server node in at least one of the timeslots, wherein the local model parameters of the local model parameter vector are transmitted in accordance with the transmission order.

36. (canceled)
